(19) United States
(12) Patent Application Publication
(10) Pub. No.: US 2013/0133254 A1
(43) Pub. Date: May 30, 2013

(54) MOLDED FIBER HANGING BASKET SYSTEM

(71) Applicant: Western Pulp Products Company, Corvallis, OR (US)

(72) Inventor: Sean O'Brien, Corvallis, OR (US)

(73) Assignee: Western Pulp Products Company, Corvallis, OR (US)

(21) Appl. No.: 13/680,982

(22) Filed: Nov. 19, 2012

Related U.S. Application Data
(60) Provisional application No. 61/565,001, filed on Nov. 30, 2011.

(51) Int. Cl. A01G 9/12; A01G 9/02

(52) U.S. Cl. CPC A01G 9/12; A01G 9/024
USPC 47/65.7; 248/318; 29/428

(57) ABSTRACT

Embodiments herein provide hangers and hanging systems for molded pulp fiber hanging pots and baskets, for instance for growing and/or displaying plants. In various embodiments, these molded pulp fiber basket systems may have a lip and/or rim onto which a set of resilient clips may attach to provide support to the basket, and the rim may have a rolled, domed, wedge-shaped, triangular, or flat profile, or any other profile that allows the clips to be mounted easily and that is capable of supporting the weight of the basket in a fully-loaded state. In various embodiments, each clip may include a retaining member and a biasing member, and may also include an optional internal and/or external structural projection. Each clip may couple to or be integral with a corresponding support strand, and all of the support strands may couple to or be integral with a hook or other hanging element.

### CROSS REFERENCE TO RELATED APPLICATIONS

The present application claims priority to U.S. Provisional Patent Application No. 61/565,001, filed Nov. 30, 2011, titled “MOLDED FIBER HANGING BASKET SYSTEM,” the entire specification of which is hereby incorporated by reference in its entirety for all purposes, except those sections, if any, that are inconsistent with this specification.

### TECHNICAL FIELD

Embodiments herein relate to the field of hanging plant systems, and, more specifically, to hanging systems for molded fiber hanging baskets and pots.

### Background

Molded fiber baskets and pots are desirable vessels for growing both ornamental and edible plants, as they are biodegradable, compostable, made with renewable materials, and they promote the healthy growth of plants and their root systems, they are breathable, and they provide insulation from temperature extremes. There are three systems in common use for suspending molded fiber plant baskets in a hanging basket configuration. In some systems, metal hangers are used that are inserted through pre-installed eyelets in the rim of the molded fiber basket or pot. These systems require a significant amount of labor and time to assemble, while introducing safety hazards to the assembler. In other systems, metal hangers are used that couple to a loop that circumscribes the molded fiber basket or pot. These are expensive and unwieldy. A third system makes use of plastic hangers. These require baskets or pots that have pre-installed eyelets or other pre-installed or molded receiving elements. These are more expensive than baskets and pots without eyelets or receiving elements, and they are labor intensive to assemble.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates a perspective view of a molded pulp fiber hanging basket system, in accordance with various embodiments;

FIG. 2 illustrates a close-up view of a portion of the molded pulp fiber hanging basket system of FIG. 1, in accordance with various embodiments;

FIG. 3A illustrates a partial cutaway view of a molded pulp fiber hanging basket system, in accordance with various embodiments;

FIG. 3B illustrates a close-up view of the molded pulp fiber hanging basket system of FIG. 3A, showing a clip engaging a rim of a molded pulp fiber hanging basket system, in accordance with various embodiments;

FIG. 3C illustrates a close-up view of the molded pulp fiber hanging basket system of FIG. 3A, showing a clip engaging an irregularity in an outside surface of the rim of a molded pulp fiber hanging basket system, in accordance with various embodiments;

FIG. 4A illustrates a perspective view of a clip for a molded pulp fiber hanging basket system, in accordance with various embodiments;

FIG. 4B illustrates a partial cutaway view of the clip of FIG. 4A, in accordance with various embodiments;

FIG. 4C illustrates a side view of the clip of FIG. 4A, in accordance with various embodiments;

FIG. 5A illustrates a diagram of a clip in a closed position for a molded pulp fiber hanging basket system, in accordance with various embodiments;

FIG. 5B illustrates a diagram of the clip illustrated in FIG. 5A in a flexed open position, in accordance with various embodiments; and

FIG. 6A-C illustrates perspective views of clips with closure mechanisms, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

Embodiments herein provide hangers and hanging systems for molded pulp fiber hanging pots and baskets, for instance for growing and/or displaying plants, such as ornamental and/or edible plants. In various embodiments, these systems may provide environmentally sensitive alternatives to plastic hanging basket systems, and may be recyclable, compostable, biodegradable, and/or made from renewable materials. Various embodiments may provide stable molded pulp fiber hanging basket systems that may be able to withstand high loading conditions, even when wet and/or exposed to environmental elements such as wind, heat, cold, sun, ice, rain, and the like. In various embodiments, the disclosed systems also may be assembled more easily, accurately, and quickly than existing molded fiber basket systems, which may make them more cost-effective and reliable. Although the terms “basket” and “pot” are used interchangeably herein to refer to the vessels suspended by the disclosed hangers, one of skill in the art will appreciate that the disclosure pertains to systems for suspending any molded pulp fiber vessels suitable for growing and/or displaying plants.

In various embodiments, a molded pulp fiber basket for use with the present disclosure may have a rim onto which a set of resilient clips may attach to provide support to the basket. In various embodiments, the rim may have a rolled, domed, wedge-shaped, triangular, or flat profile, or any other profile that allows the clips to be mounted easily and that is capable of supporting the weight of the basket in a fully-loaded state. Although it was previously thought (prior to the present disclosure) that such a molded pulp fiber rim would be insufficient to support the weight of a fully-loaded basket, particularly when wet and/or containing fully developed plants, it was surprisingly found that the rims of the molded pulp fiber baskets disclosed herein have sufficient strength to support the system in a fully loaded state (e.g., planted with moist soil and fully grown plants), even when exposed to water and long growing seasons.

Many conventional molded pulp fiber hanging basket systems make use of pre-installed eyelets in the molded fiber basket side or rim, through which barbed posts or wire strands of a hanger may be inserted. This results in an expensive and time-consuming assembly process, and a more expensive product. By comparison, the system disclosed herein makes use of resilient hanger clips that may be snapped over the lip or rim of the molded fiber pot or basket in an assembly process that is faster, easier, and uses cheaper components, since no eyelets are required.

In various embodiments, a clip for use with the disclosed system may include a retention member adapted to fit over an outside edge of the molded fiber rim, which retention member includes a hook or barb element at the open end that may be adapted to engage an outside surface of the molded fiber basket and support the weight of the basket. In some embodiments, the rim may include a lip or other lateral projection, and the barb element may be adapted to engage an underside of the lip. In some embodiments, the outside surface of the molded fiber basket may be rough and/or irregular, and the rim may have an irregular thickness. Thus, in various embodiments, the retention member may be sized and shaped to accommodate any irregularities in the outer surface of the rim and/or variations in the thickness of the rim. Some embodiments of the retention member may include retention members having a curved or arcuate shape adapted to span the rim contour.

In some embodiments, rather than engaging a laterally-projecting lip on the rim, the barb may engage one or more lumps or other surface irregularities in the rim exterior. In particular embodiments, particularly when the molded finer basket is suspended from the hanger and corresponding clips, the barb may dig into the exterior surface of the basket, and may create a localized lateral projection where it engages the rim by displacing molded pulp fiber via plastic migration to form a projection at or near the barb tip.

In various embodiments, a biasing member opposing the retention member may substantially close the clip around the rim of the basket, and may retain the clip in place. In various embodiments, the bias pressure of the biasing member may be sufficient to retain the retention member in place on the rim, even under heavy load conditions. In some embodiments, during assembly of the system, the bias of the biasing member may be overcome by exerting downward pressure on the clip against the rim of the molded fiber basket, thus causing the clip to open and fasten around the rim in a single step. In some embodiments, this process may cause an assembler less hand fatigue as compared to the assembly steps of a conventional hanging basket, and the process also may be automated if desired.

In some embodiments, the clip may include an internal and/or or external structural projection that may run along an inside and/or outside edge of the clip (e.g., along an inside and/or outside edge of at least a portion of the bias member and/or retention member). In various embodiments, this structural projection may provide strength to the clip, and/or may engage with one or more notches along the upper surface of the rim or lip as further described below. In embodiments wherein the clip has a structural projection located on an outside edge of the clip, the structural projection may give the clip structure enough strength to support the basket for an entire growing season (e.g., when fully loaded with moist soil and fully-grown plants). In various embodiments that do not use such a structural projection, the clip may have a greater thickness or include additional material to give the clip sufficient strength, which may increase the cost and weight of the clip.

In various embodiments, such internal and/or external structural projections also may engage a plurality of notches or other indentations along the upper rim or lip of the baskets and pots disclosed herein. In some embodiments, engagement of external structural projections with notches or indentations in the rim or lip of the basket may facilitate the assembly of the hanging basket system, for instance by providing a tactile indication of where an assembler should position the hanger clips along the rim of the basket, so that the weight of the system may be evenly distributed among the clips and their respective support strands. For example, in some embodiments, as described in greater detail below, the clips may include an external structural projection or other feature that may engage with a notch in the rim or lip during assembly, allowing the correct location for the clip to be felt by the assembler as he or she moves the clip over the rim or lip. In other embodiments, these notches or indentations also may be adapted to engage with a corresponding structural projection on the inner surface of the clip, as further described below.

In some embodiments, the clip may be a one-piece clip, and in particular embodiments, the clip may be part of a one-piece basket hanger that includes multiple clips coupled to corresponding support strands and, optionally, a hook, loop, or other element that may be used to suspend the hanging basket. In various embodiments, three, four, five, six, seven, eight, nine, ten, eleven, twelve, or even more support strands may be used. In particular embodiments, the strands may differ in length. For example, in some embodiments, such lengths may correspond to a length necessary to maintain the hanging basket in a level position and/or balance load among the support strands regardless of where the support strand meets or transitions into the hook or other hanging element.

In some embodiments, the clip may include a locking mechanism such as a snap, a through post, a retention ring, or one or more hooks adapted to retain the clip in a closed position once it has be positioned on the rim of the basket. In some embodiments, the locking mechanism may pass through an aperture in the wall or rim of the basket, whereas in other embodiments, the locking mechanism may fasten above the rim of the basket. Such locking mechanisms are discussed at greater length below.

In various embodiments, the asymmetrical design of the clip (e.g., the outer retention member and opposing biasing member) may ensure that the clips are installed correctly for a secure fit. For example, if a clip were installed incorrectly, with the orientation of the clip rotated 180 degrees relative to the rim of the pot, it would be visually clear that the clip had been installed incorrectly, since the strand would project outward from the rim and the clip would not seat properly on the rim.

In some embodiments, the clip, strands, and/or hanger may be made of plastic, nylon, polypropylene, or LDPE, although in other embodiments, the clip may be made from metal, rubber, or another elastomer or polymer that is sufficiently strong and resilient to support the weight of the molded fiber basket or pot from its lip or rim.

In some embodiments, the molded baskets and pots disclosed herein may include natural or plant-based materials, such as natural fibers, particles, and/or biopolymers, which may be formed, in some embodiments, in a molding process. In various embodiments, such natural or plant-based materials may include pulp fibers, such as paper, newsprint, corrugated, waxed cup stock, and/or non-waxed cup stock, and/or other plant-based fibers, such as bark, wood, miscanthus grass, hemp, bamboo, coconut, other grasses, and/or palm fiber. In various embodiments, other examples of plant-based materials may include cassava, tapioca, corn, paper foam, starches, and/or various other agricultural fibers and organic materials. Some embodiments of the molded fiber pots and/or baskets may be coated or permeated with wax or another water-resistant material to extend the life and increase the strength of the pots and/or baskets. Although the pots and baskets disclosed herein typically include plant-based materials, one of skill in the art will appreciate that they also may include some amounts of other formable and/or moldable materials, such as plastic, expanded polystyrene, alloys, hydrocarbon-based materials, synthetic fibers, and other organic and inorganic materials.

Although the examples of molded pulp fiber baskets and pots illustrated in the figures are round pots, one of skill in the art will appreciate that systems disclosed herein also may include or be used with pots and baskets having other shapes, such as square, rectangular, oval, oblong, triangular, and hexagonal pots and baskets. Furthermore, as described above, the baskets and pots disclosed herein may have one or more surfaces that are rough or irregular, for example an irregular exterior surface if the basket or pot is manufactured using a typical pulp fiber molding process. In various embodiments, if the rim or lip of the basket has one or more irregular surfaces, for instance an irregular underside to the lip or outside surface of the rim, the clip may be configured to have extra clearance between the inside surface of the clip and the top of the rim when coupled to the basket (e.g., extra clip height), allowing the clip to span any irregularities in the contour of the lip or rim. In various embodiments, this extra clearance may prevent the clip from failing to seat properly over a lump and sliding off the lip of the pot when hung by the hanger.

By contrast, in some embodiments, the lip of the basket may be subjected to post-pressing to give it a uniform thickness, or the basket may be formed with smooth surfaces using a thermoforming or compression process. In these embodiments, the clip may be configured to have less clearance over the rim when coupled to the basket (e.g., less clip height). In these embodiments, post-processing or thermoforming may add additional cost to the manufacturing process in labor, time, and machinery, but this cost also may be at least partially offset by a reduction in the amount of material needed for the shorter clips. .

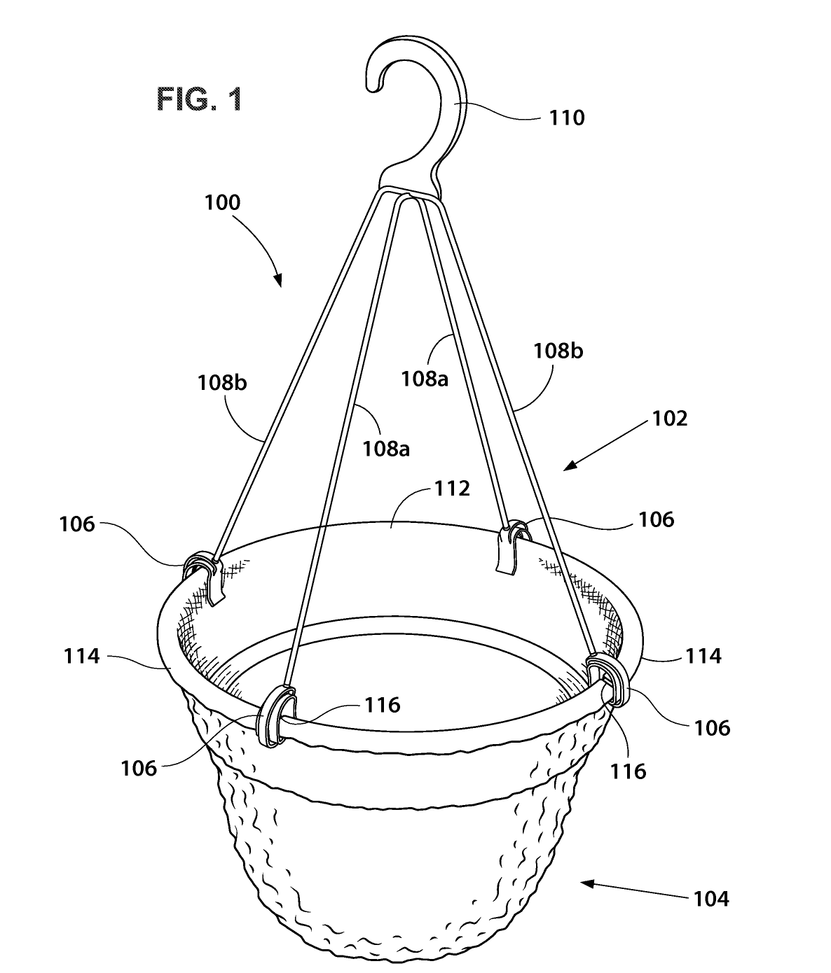

FIG. 1 illustrates a perspective view of a molded pulp fiber hanging basket system, in accordance with various embodiments. Referring now to FIG. 1, in various embodiments, molded pulp fiber hanging basket system 100 may include a hanger 102 and a molded pulp fiber basket 104. In various embodiments, hanger 102 may include a plurality of clips 106 that are coupled to or integral with a corresponding plurality of support strands 108. In various embodiments, the plurality of support strands 108, in turn, couple to or are integral with a hook 110 or other hanging member. In some embodiments, support strands 108 may be integral with hook 110, and they may transition into hook 110 at different locations. For example, in the illustrated example, central support strands 108a may transition into hook 110 near the center of hook 110, whereas peripheral support strands 108b may transition into hook 110 towards the periphery. In some embodiments, central support strands 108a may be longer than peripheral support strands 108b so that basket 104 remains level when supported by all of the support strands 108.

In various embodiments, basket 104 may include an upper edge or rim 112, optionally having a lip 114 configured to be able to support the weight of basket 104, even when fully loaded with moist soil and fully grown plants. In various embodiments, rim 112 and/or corresponding lip 114 may have a rolled, rounded, domed, wedge-shaped, triangular, or flat contour. In particular embodiments, rim 112 may include a plurality of notches 116 that may be used for locating corresponding clips 106.

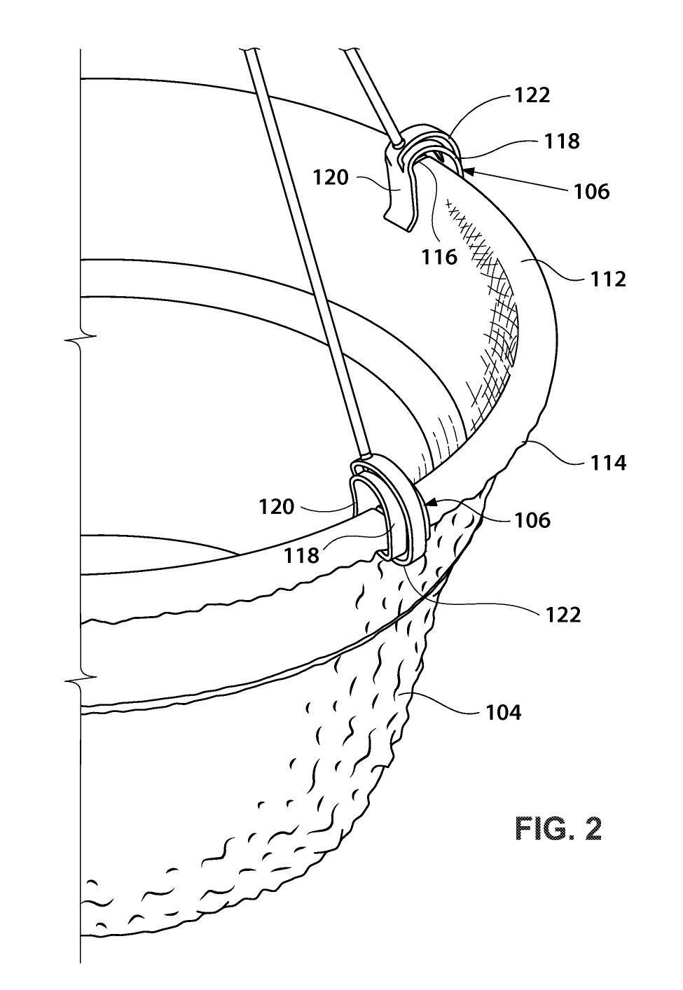

FIG. 2 illustrates a close-up view of a portion of the molded pulp fiber hanging basket system of FIG. 1, in accordance with various embodiments. Referring now to FIG. 2, clips 106 may include a retention member 118 adapted to fit over an outside edge of molded pulp fiber rim 112. In various embodiments, retention member 118 may include a hook or barb element (not shown) at the open end that may be adapted to engage lip 114 and support the weight of basket 104. In various embodiments, the curvature and/or height of retention member 118 may be sized and shaped to allow for some variability in lip/rim thickness and shape. For example, baskets 104 having a thicker rim 112 or lip 114 may require a taller clip 106 in order to seat securely on rim 112 and provide a sufficient grip to support the weight of basket 106. Similarly, baskets 104 having a lip 112 or rim 114 with an irregular thickness may require a taller clip. Conversely, thinner and/or more regular rims 112 and/or lips 114 may be used with a shorter clip 106 having less internal clearance above rim 112. In various embodiments, reducing the height of clip 106 may increase the gripping power of clip 106.

In various embodiments, a biasing member 120 opposite from retention member 118 and oriented towards the interior of basket 106 may substantially close and secure clip 106 around rim 112 and lip 114 of basket 104, and may retain clip 106 in place. In various embodiments, the bias pressure of biasing member 120 may be sufficient to retain the retention member in place on the rim, even under heavy load conditions. In some embodiments, the rim 112 may not include a lip 114. In various embodiments, barb member may be adapted to engage an outer surface of rim 112, for example one or more surface irregularities forming a lateral projection. In some embodiments, the bias pressure and/or weight of the system may be sufficient to cause the barb to dig into the outer surface and displace some molded pulp fiber material to form a lateral projection via plastic migration.

In some embodiments, clip 106 may also include an external structural projection 122 that may run along an outside edge at least a portion of retention member 118. In various embodiments, external structural projection 122 may provide strength to clip 106, and/or may engage with one or more notches 116 along the upper surface of the rim 112 during assembly as further described below. Although the illustrated structural projections are shown as having a rib shape, one of ordinary skill in the art will appreciate that the structural projections may have any shape that provides sufficient support to the clip to keep it closed when under load.

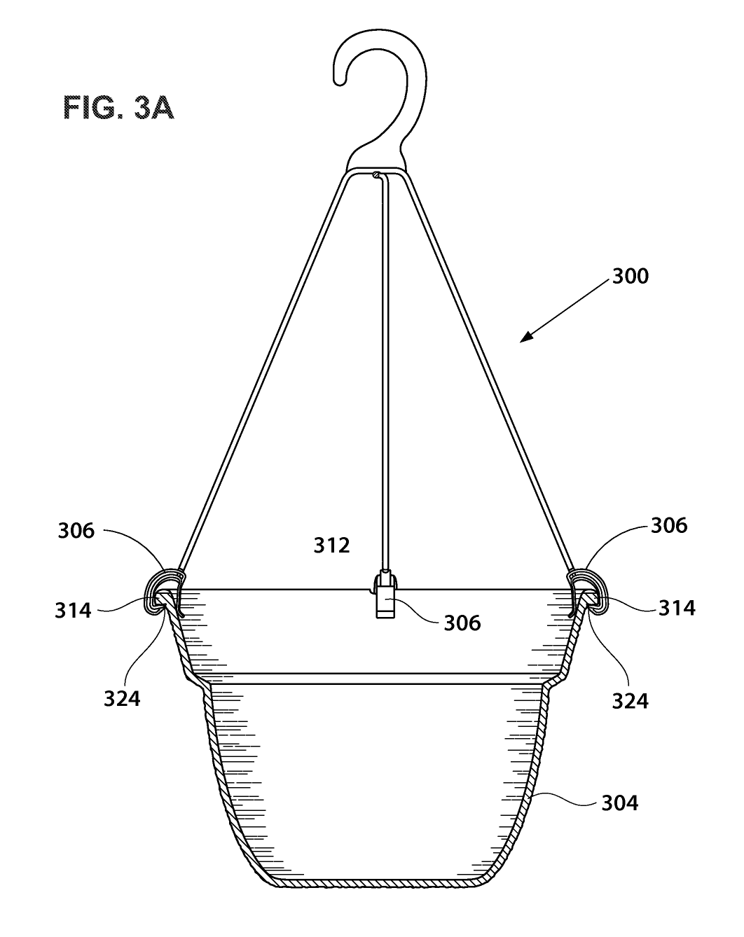

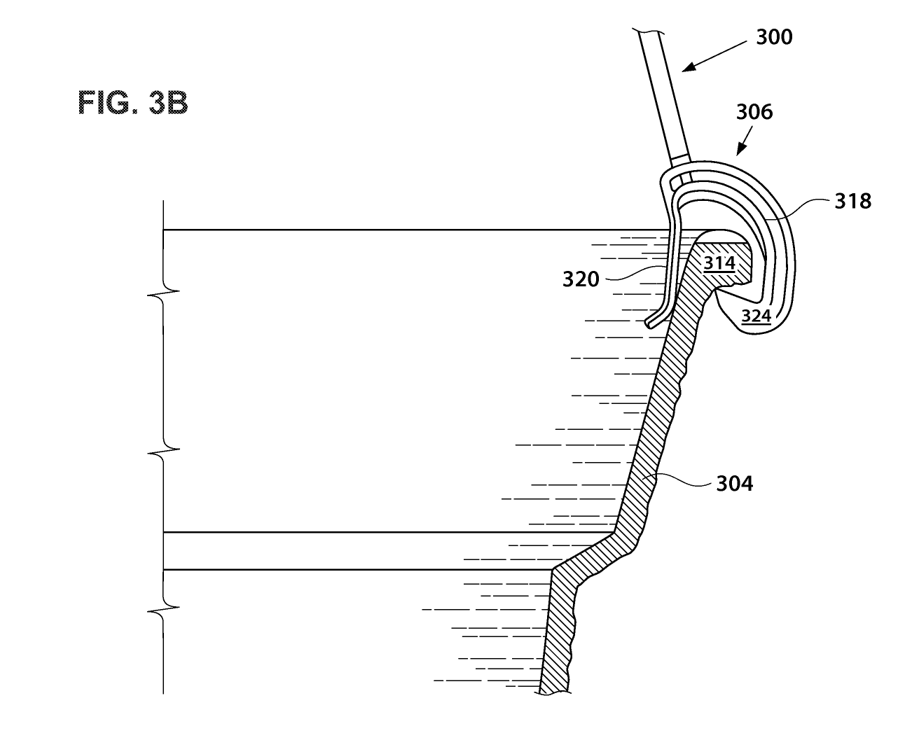

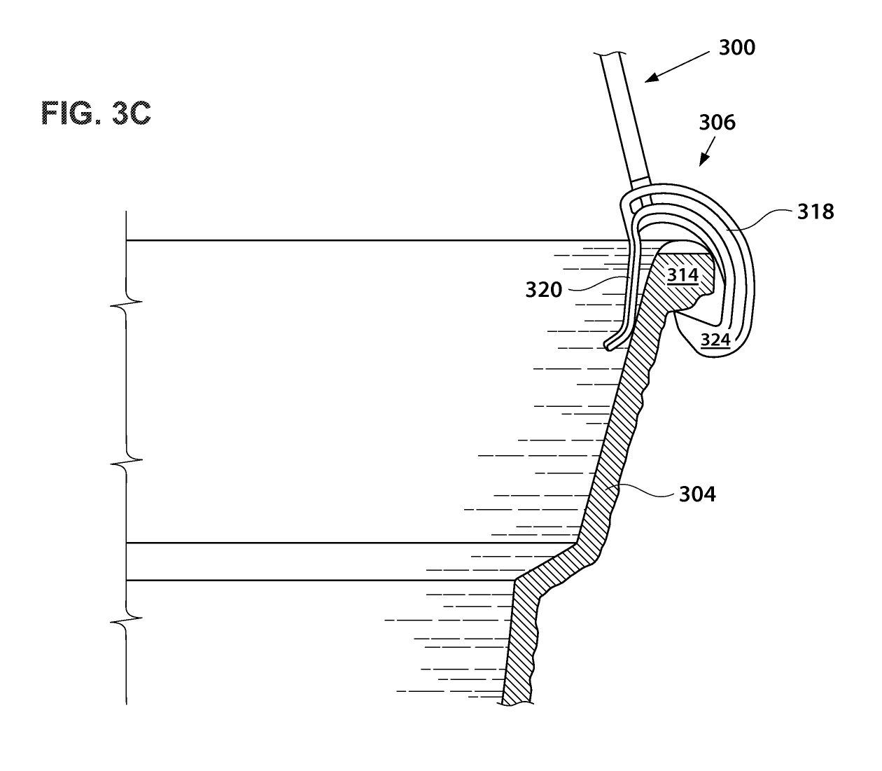

FIGS. 3A, 3B, and 3C illustrate partial cutaway views of a molded pulp fiber hanging basket system, in accordance with various embodiments. Referring now to FIG. 3A, an embodiment of system 300 is illustrated wherein basket 304 has a rim 312 having a substantially irregular thickness. In this embodiment, clip 306 is shown with barb 324 engaging the underside of lip 314, thus providing support to basket 304.

FIG. 3B illustrates a close-up view of the molded pulp fiber hanging basket system300 of FIG. 3A, showing barb 324 of retention member 318 of clip 306 engaging an underside of a lip 314 of the molded pulp fiber basket 304, in accordance with various embodiments. In various embodiments, biasing member 320 may provide sufficient bias pressure to retain clip 306 in a substantially closed position, even under heavy loads. FIG. 3C illustrates a close-up view of the molded pulp fiber hanging basket system 300 of FIG. 3A, showing barb 324 engaging an irregularity in an outside surface of the rim 312. In some embodiments, such surface irregularities may cause the clip to engage with the rim at a more shallow angle. In these embodiments, the bias pressure of the biasing member 320 may increase as the clip 306 opens wider to accommodate the irregularity. In some embodiments, such increased bias pressure may increase the engagement of the barb 324 with the rim. In some embodiments, suspending the molded pulp fiber basket from the hanger also may cause clip 306 to rotate, thereby increasing the biasing pressure pinching clip 306 on the rim 312 and the bite of clip 306 on the outer surface of the irregular rim 312.

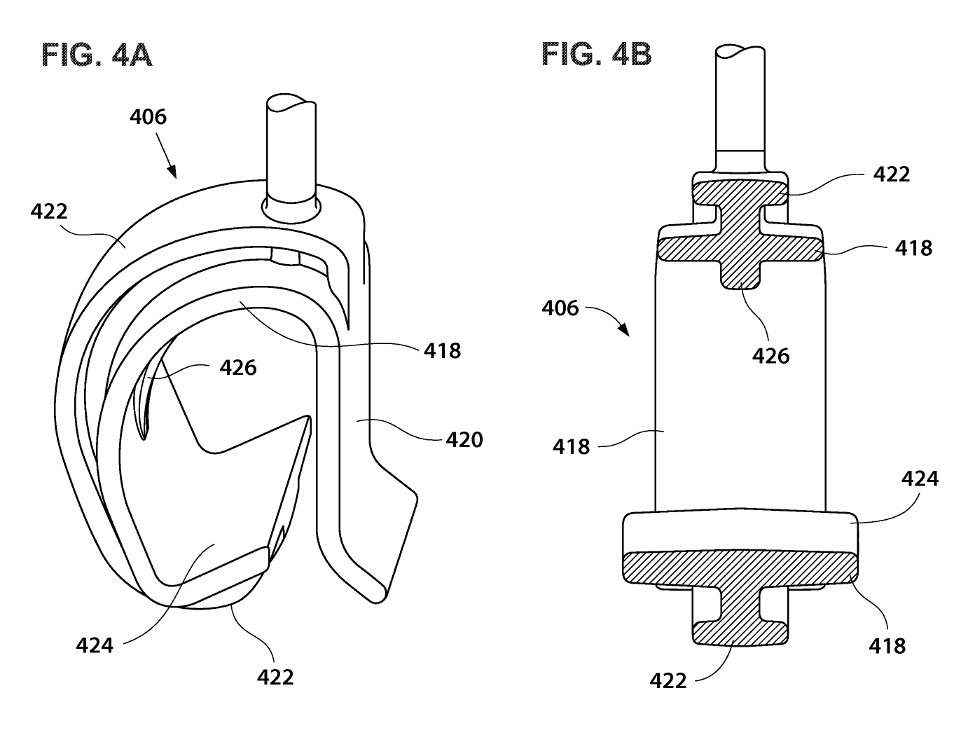

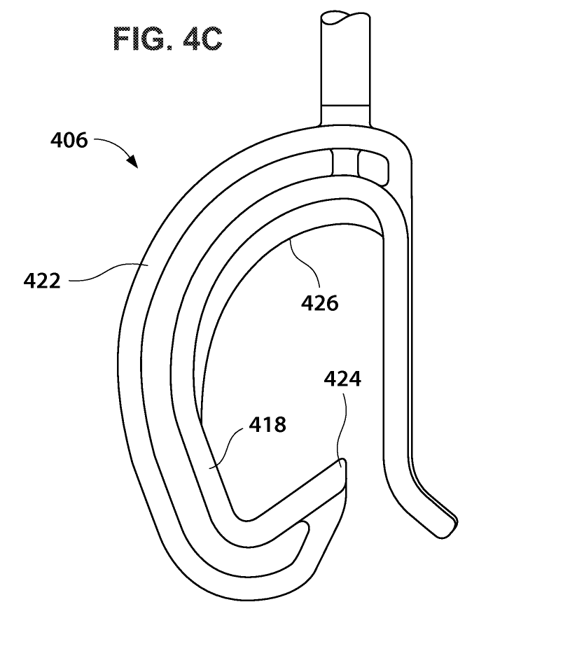

FIGS. 4A, 4B, and 4C illustrate a perspective view (FIG. 4A), a partial cutaway view (FIG. 4B), and a side view (FIG. 4C) of a clip for a molded pulp fiber hanging basket, in accordance with various embodiments. Turning now to FIG. 4A, in various embodiments, clip 406 may include a retention member 418 and a biasing member 420, and retention member 418 may include an external structural projection 422 that may extend the length of substantially all of the exterior surface of retention member 418, including at least a portion of barb 424, and that may resist the outward flexion of retention member 418. In some embodiments, retention member 418 also may include an interior structural projection 426, which may further resist the outward flexion of retention member 418.

FIG. 4B illustrates a partial cutaway view of the clip of FIG. 4A, in accordance with various embodiments. As shown in FIG. 4B, clip 406 may include retention member 418, which may also include barb 424, which may be adapted to engage the underside of the lip of the basket or other outside surface of the molded pulp fiber basket. As illustrated, in various embodiments, external structural projection may project outwardly from retention member 418, and may have a T-shape when viewed in cross section. In various embodiments, interior structural projection 426 may be positioned opposite exterior structural projection 422 on an interior surface of retention member 418. In various embodiments, interior structural projection 426 may be configured to engage with a corresponding notch on the rim of the basket (not shown).

FIG. 4C illustrates a side view of the clip of FIG. 4A, in accordance with various embodiments. As shown in FIG. 4C, external structural projection 422 may extend along substantially the full length of retention member 418 and barb 424. By contrast, interior structural projection 426 may extend over only a portion of the interior of retention member 418.

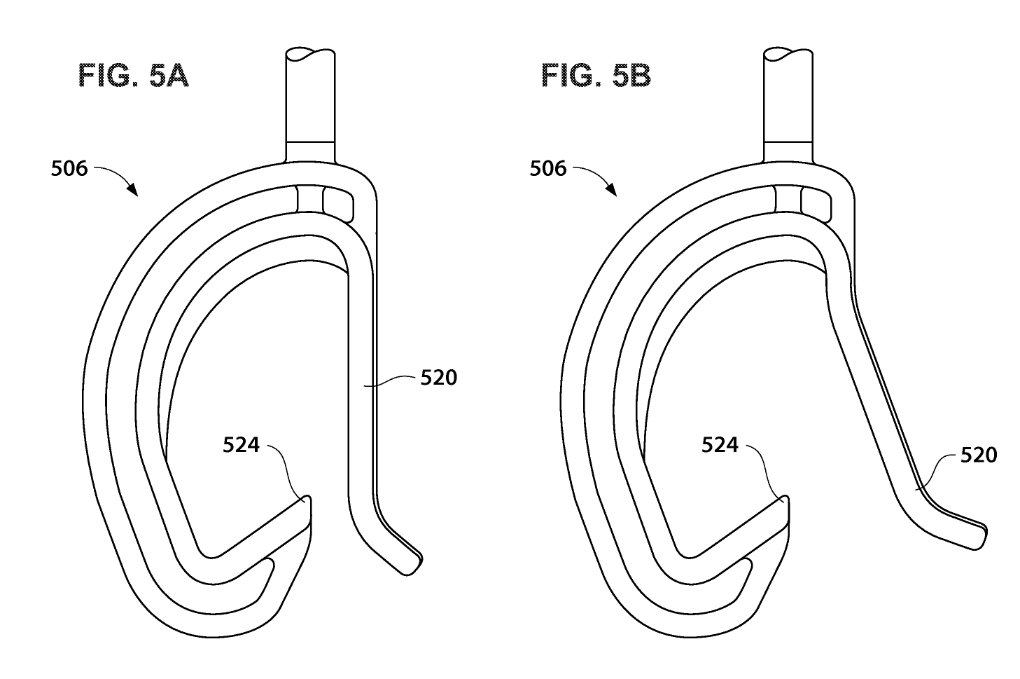

FIG. 5A illustrates a diagram of a clip in a closed position for a molded fiber hanging basket system, and FIG. 5B illustrates a diagram of the clip illustrated in FIG. 5A in an open position, in accordance with various embodiments. Referring now to FIGS. 5A and 5B, biasing member 520 of clip 506 is biased towards the closed position, with its distal end near barb 524 (FIG. 5A). When tension is exerted on biasing member 520, it moves away from barb 524, which may allow the rim and lip of the basket to pass by barb 524 and into the interior of clip 506.

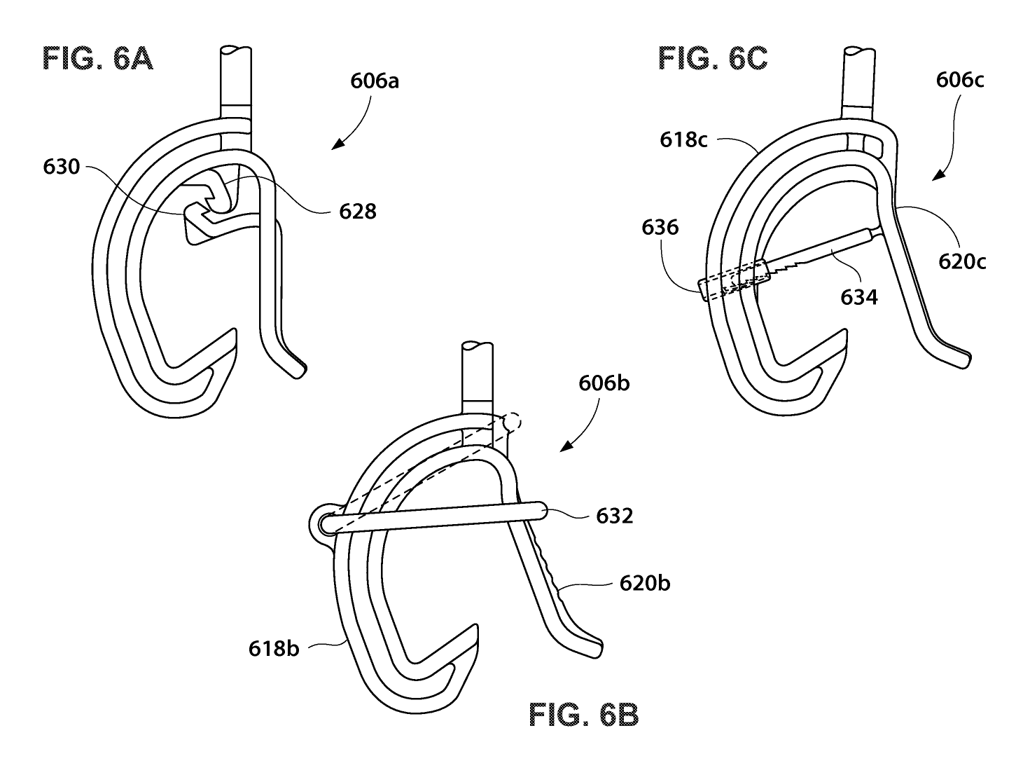

FIG. 6 illustrates a perspective view of three clips with locking mechanisms, in accordance with various embodiments. FIG. 6A shows an example of a clip 606a having a pair of mated interior hooks 628, 630. As illustrated in FIG. 6A, when upward pressure is exerted on lower interior hook 630, for example from the upper surface of the rim of a molded pulp fiber basket, lower interior hook 630 engages with upper interior hook 628, thus locking clip 606a in a closed position. In various embodiments, mated interior hooks 628, 630 also may engage with each other and lock clip 606a in a closed position when clip 606a is squeezed into a closed position.

Similarly, FIG. 6B shows an embodiment of clip 606b, wherein the clip includes a locking ring 632 that may be slid downward over both retaining member 618b and biasing member 620b. In various embodiments, when locking ring 632 is moved downward over both retaining member 618b and biasing member 620b, it may prevent retaining member 618b and biasing member 620b from separating, thereby locking clip 606b in a closed position. In some embodiments, locking ring 632 may rest on the rim of the molded pulp fiber basket (not shown) when in the locked position, whereas in other embodiments, locking ring 632 may snap into a notch or groove (not shown) on the exterior of clip 616b when in the locked position.

As illustrated in FIG. 6C, a third embodiment 606c includes a through-post 634 extending from biasing member 620c and passing through an aperture 636 in retaining member 618c (or vice versa). In various embodiments, when post 634 snaps into place in aperture 636, it may prevent retaining member 618c and biasing member 620c from separating, thereby locking clip 606c in a closed position.

In use, the hanging basket system is generally provided as two separate components (e.g., the molded pulp fiber basket and the hanger) and assembled on site. For example, in various embodiments, the clips may be coupled to the molded fiber basket rim simply by positioning the clip with the retaining member facing the outside of the basket and the biasing member facing toward the interior of the pot, and pushing the clip down onto the rim with sufficient force to overcome the bias force of the biasing member. In various embodiments, this assembly process may be carried out without the risk of injury or hand fatigue to the assembler. In particular embodiments, the assembly process may be automated.

In various embodiments, an assembler may know that the clip is properly seated on the rim when he or she hears or feels an audible or tactile click of the clip engaging with the rim. Additionally, in various embodiments, an assembler will notice if the clip fails to seat properly on the rim or is installed backwards because the corresponding support strand will project in the wrong direction (e.g., outward, away from the molded pulp fiber basket) and/or the clip will slip off the rim. In various embodiments, proper seating of the clip may be important for the safety of the user and to prevent the molded pulp fiber basket from falling from the hanger, particularly when in a loaded state.

In some embodiments, before coupling the clip to the rim of the molded pulp fiber basket, an assembler may pass the clip over a portion of the surface of the rim until he or she feels the clip engage with a notch on the rim. In various embodiments, this engagement may provide tactile feedback to the assembler to verify that the clip is correctly positioned on the rim to balance the load of the basket evenly between all of the clips and their respective strands. In various embodiments, once all of the clips have been securely seated in the proper positions along the rim, and optional locking mechanisms have been engaged, if present, the hanging basket system may be filled with planting medium and/or plants (e.g., if not filled prior to assembly) and hung by the hook or other hanging member.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

I claim:

1. A molded fiber hanging basket system, wherein the system comprises:
a molded fiber pulp basket having a molded pulp fiber rim member; and
a hanger comprising:
a hook member adapted to support the hanging basket system from above;
a plurality of support strands adapted to transmit the weight of the molded pulp fiber basket to the hook member; and
a corresponding plurality of one-piece resilient clip bodies adapted to couple to and support the molded pulp fiber basket via each corresponding support strand, each clip body comprising:
a retention member adapted to span the molded pulp fiber rim member of the molded pulp fiber basket, the retention member terminating in a barb adapted to grip an outside surface of the molded pulp fiber basket; and
an integral biasing member, wherein the integral biasing member opposes the retention member and biases the clip in a closed position.

2. The molded fiber hanging basket system of claim 1, wherein the clip body further comprises an integral external structural projection spanning at least a portion of an exterior surface of the retention member, wherein the external structural projection is adapted to prevent outward flexion of the retention member when the barb engages a load.

3. The molded fiber hanging basket system of claim 2, wherein the integral external structural projection spans substantially all of the exterior surface of the retention member.

4. The molded fiber hanging basket system of claim 2, wherein the integral external structural projection spans at least a portion of the barb.

5. The molded fiber hanging basket system of claim 1, wherein the molded fiber rim member comprises a molded pulp fiber lip member projecting laterally therefrom, and wherein the barb is adapted to engage an underside of the molded fiber lip member.

6. The molded fiber hanging basket system of claim 2, wherein the molded pulp fiber basket comprises a plurality of notches in the rim surface, and wherein the integral external structural projection is configured to engage with a notch during an assembly procedure.

7. The molded fiber hanging basket system of claim 2, wherein each clip further comprises an internal structural projection, wherein the interior structural projection is adapted to prevent outward flexion of the retention member when the barb engages a load.

8. The molded fiber hanging basket system of claim 1, wherein each clip is further adapted to couple to each corresponding support strand.

9. The molded fiber hanging basket system of claim 1, wherein each clip is integral with each corresponding support strand.

10. The molded fiber hanging basket system of claim 1, wherein each clip further comprises a locking mechanism adapted to lock the clip into the closed position.

11. The molded fiber hanging basket system of claim 10, wherein the locking mechanism comprises a pair of internal hook members, a locking ring, a locking through-post, or a combination thereof.

12. The molded fiber hanging basket system of claim 1, wherein each clip body comprises nylon, polypropylene, LDPE, another plastic, or a combination thereof.

13. The molded fiber hanging basket system of claim 12, wherein each clip body is integral with each corresponding support strand, and wherein each support strand is integral with the hook member.

14. The molded fiber hanging basket system of claim 1, wherein the molded pulp fiber basket comprises natural fibers, particles, and/or biopolymers.

15. The molded fiber hanging basket system of claim 14, wherein the natural fibers, particles, and/or biopolymers comprise paper, newsprint, corrugated, waxed cup stock, and/or non-waxed cup stock, bark, wood, miscanthus grass, hemp, bamboo, palm fiber, coconut, cassava, tapioca, corn, paper foam, a starch, or a combination thereof.

16. The molded fiber hanging basket system of claim 14, wherein the molded pulp fiber basket is permeated or coated, fully or partially, with wax or another water resistant material applied to extend the life/strength of the container.

17. A hanger for a molded pulp fiber hanging basket system, wherein the hanger comprises:
a hook member adapted to support the hanging basket system from above;
a plurality of support strands adapted to transmit the weight of a molded pulp fiber basket to the hook member; and
a corresponding plurality of one-piece resilient clip bodies adapted to couple to and support the molded pulp fiber basket via each corresponding support strand, each clip body comprising:
a retention member adapted to span a molded pulp fiber rim member of the molded pulp fiber basket, the retention member terminating in a barb adapted to grip an outside surface of the molded pulp fiber basket;
an integral biasing member, wherein the integral biasing member opposes the retention member and biases the clip in a closed position; and
an integral external structural projection spanning at least a portion of an exterior surface of the retention member, wherein the external structural projection is adapted to prevent outward flexion of the retention member when the barb engages a load.

18. The hanger of claim 17, wherein the integral external structural projection spans substantially all of the exterior surface of the retention member.

19. The hanger of claim 17, wherein the integral external structural projection spans at least a portion of the barb.

20. The hanger of claim 17, wherein the molded fiber rim member comprises a molded fiber lip member projecting laterally therefrom, and wherein the barb is adapted to engage an underside of the molded fiber lip member.

21. The hanger of claim 17, wherein the integral external structural projection is configured to engage with a corresponding notch on the molded pulp fiber rim member during an assembly procedure.

22. The hanger of claim 17, wherein each clip further comprises an internal structural projection, wherein the interior structural projection is adapted to prevent outward flexion of the retention member when the barb engages a load.

23. The hanger of claim 17, wherein each clip is further adapted to couple to each corresponding support strand.

24. The hanger of claim 17, wherein each clip is integral with each corresponding support strand.

25. The hanger of claim 17, wherein each clip further comprises a locking mechanism adapted to lock the clip into the closed position.

26. The hanger of claim 25, wherein the locking mechanism comprises a pair of internal hook members, a locking ring, a locking through-post, or a combination thereof.

27. The hanger of claim 17, wherein each clip body comprises nylon, polypropylene, LDPE, another plastic, or a combination thereof.

28. The hanger of claim 27, wherein each clip body is integral with each corresponding support strand, and wherein each support strand is integral with the hook member.

29. A method of coupling a hanger to a molded pulp fiber basket comprising:
locating three or more hanger clips at desired locations on a molded pulp fiber basket rim, wherein a corresponding plurality of one-piece resilient clip bodies adapted to couple to and support the molded pulp fiber basket via each corresponding support strand, each hanger clip comprising:
a retention member adapted to span the molded pulp fiber rim, the retention member terminating in a barb adapted to grip an outside surface of the molded pulp fiber basket;
an integral biasing member, wherein the integral biasing member opposes the retention member and biases the clip in a closed position; and
an integral external structural projection spanning at least a portion of an exterior surface of the retention member, wherein the external structural projection is adapted to prevent outward flexion of the retention member when the barb engages a load; and
exerting sufficient downward pressure on each clip to overcome a bias of the bias member and allow the retention member to span the rim.
